(19) United States
(12) Patent Application Publication
(10) Pub. No.: US 2010/0133489 A1
(43) Pub. Date: Jun. 3, 2010

(54) Photoinduced phase separation of gold in two-component nanoparticles to form nanoprisms

(75) Inventors: Chad A. Mirkin, Wilmette, IL (US); Gabriella Metraux, Hillsboro, OR (US); Rongchao Jin, Pittsburgh, PA (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: NORTHWESTERN UNIVERSITY, Evanston, IL (US)

(21) Appl. No.: 11/715,562

(22) Filed: Mar. 8, 2007

Related U.S. Application Data
(60) Provisional application No. 60/782,678, filed on Mar. 8, 2006.

(51) Int. Cl. F21V 9/04; B05D 3/06

(52) U.S. Cl. 252/587; 427/595; 977/700

(57) ABSTRACT

Nanoprisms containing silver and gold are disclosed. The nanoprisms exhibit the properties of pure silver nanoprisms, but are less susceptible to silver modification or reaction by a surrounding environment than pure silver nanoprisms due to the presence of the gold. The gold surface of the nanoprisms can be further modified, using known gold-modification techniques.

### CROSS-REFERENCE TO RELATED APPLICATIONS

This application claims the benefit of U.S. Provisional Application Ser. No. 60/782,678, filed Mar. 8, 2006, which is incorporated herein in its entirety by reference.

### STATEMENT OF GOVERNMENT INTEREST

This invention was made with U.S. government support under National Science Foundation (NSF-NSEC) grant No. EEC-011-8025. The government has certain rights in this invention.

### BACKGROUND

Since the early twentieth century, substantial research has focused on understanding the physical and chemical properties of metals at the nanoscale. Nanoscale particles of gold (Au) and silver (Ag) have been a primary target of this research due to their optical properties, which exhibit a remarkable dependence on nanoparticle size, composition, and shape (Mie, Ann. Phys. 23:377 (1908); Kreibig et al., Surface Science 156:678 (1985); Lieber, Solid State Comm 107:607 (1998); El-Sayed, Acc Chem. Res. 34(4):257 (2001); Mayer et al., Colloid Polym. Sci 276:769 (1998)). To date, most synthetic methods have been limited to producing highly faceted and/or pseudo-spherical species, which precludes a systematic investigation of the effects of shape on the nanoparticle properties. Over the past several years, new chemical and photochemical synthetic approaches have been developed that allow production of gold and silver nanoparticles in a variety of shapes, including cubes (Ahmadi et al., Science 272:1924-1926 (1996); Ahmadi et al., Chem. Mater. 1161-1163 (1998); Jin et al., J Am. Chem. Soc. 126:9900-9901 (2004); Sau et al., J Am. Chem. Soc. 126:8648-8649 (2004)), rings (Tripp et al., J Am. Chem. Soc. 124:7914-7915 (2002)), disks (Hao et al., J. Am. Chem. Soc. 124:15182-15183 (2002)), rods (Yu. et al., J. Phys. Chem. B 101:6661-6664 (1997); Jana et al., J. Phys Chem. B 105:4065-4067 (2001); Kita et al., J Am. Chem. Soc. 124:14316-14317 (2002); Zhou et al., Adv. Mater. 11:850-852 (1992); Puntes et al., Science 291:2115-2117 (2001); Nikoobakht et al., Chem. Mater. 15:1957-1962 (2003); Ah et al., J. Phys. Chem. B 1105:7871-7873 (2001)), and triangular prisms (Hulteen et al., J. Phys. Chem. B 103:3854-3863 (1999); Bradley et al., J. Am. Chem. Soc. 122:4631-4636 (2000); Chen et al., Nano Lett 2:1003-1007 (2002); Morales et al., Science 279:208-211 (1998); Jin et al., Science 254:1901-1903 (2001); Jin et al., Nature 425:487-490 (2003); Metraux et al., Adv. Mater. 17:412-415 (2005); Sun et al., Nano Lett. 2:165-168 (2002) Callegari et al., Nano Lett. 3:1565-1568 (2003); Millstone et al., J. Am. Chem. Soc. 127:5312-5313 (2005); Turkevich et al., Discussions Faraday Soc. 11:55-75 (1951); Shankar et al., Nature Mater. 3:492-488 (2004)). These new techniques provide better control over nanoparticle morphology, which has allowed investigations of how particle shape influences the physical and chemical characteristics of nanoscale materials.

Recently, a novel photo-mediated process for converting small silver nanoparticles into triangular nanoprisms over a size range of 40-150 nm has been developed (Chen et al., Nano Lett 2:1003-1007 (2002); Morales et al., Science 279:208-211 (1998)). In addition to their unusual shape, silver nanoprisms exhibit plasmon resonances that directly correlate with their architectural parameters. Indeed, structures can be made with resonances that span the entire visible region of the spectrum and a part of the near IR spectrum. Although bulk scale syntheses for nanoprisms have been developed via a variety of other routes, the photo-mediated process thus far provides the greatest control over resulting structure and particle uniformity. To date, however, this methodology has been limited to silver. Hence, new synthetic methods that provide complex (e.g., non-spherical) nanostructures composed of more than one metal would enable access to valuable new nanoparticle structures.

### SUMMARY

Disclosed herein is a method of preparing nanoprisms from a two-metal nanoparticle. More specifically, a method of preparing a nanoprism from a two-metal alloy nanoparticle or from a core-shell two-metal nanoparticle is disclosed. The method comprises preparing the two-metal nanoparticle and irradiating the resulting two-metal nanoparticle or a two-metal alloy nanoparticle, e.g., silver and gold, with a light source to form a nanoprism. The resulting nanoprism comprises a silver nanoprism having gold particles on the nanoprism surface. This method provides two-metal nanoprisms having properties similar to pure silver nanoprisms.

Also disclosed herein are two-metal nanoprisms prepared by irradiating a two-metal nanoparticle with a light source for a length of time sufficient to form the nanoprisms. The resulting two-metal nanoprisms are less reactive than pure silver nanoprisms. The gold component of the two-metal nanoprisms protects the silver component from undesired interactions with a surrounding environment. Furthermore, the two-metal nanoprisms can be surface modified, due to the presence of the gold, using known gold-modification techniques for use in various therapeutic and/or diagnostic applications.

Another aspect of the present invention is to provide a method of using nanoprisms of the present invention to identify target compounds. The method comprises interacting a target compound with a surface-modified two-metal nanoprism, wherein a surface of the gold component is modified with a moiety capable of interacting selectively with the target compound, and this interaction is detectable. In some embodiments, a surface-modified nanoprism is used in a diagnostic or therapeutic application.

### BRIEF DESCRIPTION OF THE DRAWINGS

FIG. 1. (A) Ultraviolet-visible (UV-Vis) spectra of nanoprisms derived from core-shell nanoparticles with various Ag:Au ratios. (B) Transmission electron microscope (TEM) image of bimetallic nanoprisms (Ag:Au=10:1). Inset: High Resolution TEM (HRTEM) image of the same sample.

FIG. 2. Scanning TEM (STEM)-energy dispersive X-ray spectroscopy (EDS) analysis of a nanoprism derived from core-shell nanoparticles. (A) STEM image; (B) EDS analysis of the silver nanoprism matrix (spot 1); (C) EDS analysis of the surface structure after gold deposition (spot 2). The silver signal in spot 2 arises from the underlying silver nanoprism matrix.

FIG. 3. Photoconversion reaction of alloy nanoparticles. (A) UV-vis spectra of the initial alloy nanoparticles with various Ag:Au ratios. (B) UV-vis spectra of the resulting nanoprisms after photoconversion is complete. (C) TEM image of bimetallic nanoprisms (Ag:Au=10:1) derived from alloy nanoparticles. (D) SEM-EDS analysis of the final nanoprisms (Ag:Au=10:1) demonstrating that both metals are present in the sample.

FIG. 4. Photoinduced phase separation of Au from Ag in bimetallic nanoparticles. Silver is partially oxidized by dissolved O₂ to form cationic clusters. These clusters dissociate from the nanoparticle surface and proceed to plate onto the growing nanoprisms. Silver is essentially leached out of the bimetallic seeds. Gold remains in the reduced state and thus cannot separate from the initial seed matrix.

FIG. 5. SEM-EDS analysis of core-shell nanoparticles before (A) and after (B) photoconversion to nanoprisms.

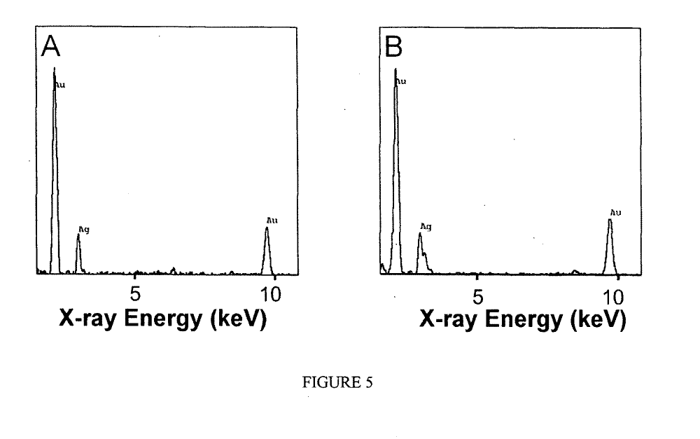

### DETAILED DESCRIPTION

Disclosed herein are nanoprisms derived from two-metal alloys or two-metal core-shell structures. These nanoprisms exhibit both the desired physical properties of silver in a nanoprism, such as for use in surface plasmon resonance labeling and the like, while protecting the silver from reacting with potential reagents in a surrounding environment. These present nanoprisms, therefore, allow for the beneficial use of silver nanoprisms in a protected form due to gold on the surface of the nanoprism. While silver and gold are used throughout this disclosure, any silver alloy or silver core-shell structure with any metal which is insoluble in silver oxide can be employed in the disclosed methods. A nonlimiting example of such a metal is copper.

The gold on the surface of the two-metal nanoprisms is prevented from self-nucleating, thereby avoiding aggregation of the gold. Furthermore, gold on the nanoprism surface allows for other components to be associated with or attached to the nanoprisms using known modification methods. Such modification includes attachment of biomolecules, oligonucleotides, proteins, antibodies, and the like, as disclosed in, e.g., U.S. Pat. Nos. 6,361,944; 6,506,564; 6,767,702; and 6,750,016; and U.S. Patent Publication No. 2002/0172953; and in International Publication Nos. WO 98/04740; WO 01/00876; WO 01/51665; and WO 01/73123, the disclosures of which are incorporated by reference in their entirety. After the gold on the nanoprism surfaces has been modified, the nanoprisms can be used in various target identification, therapeutic, and/or diagnostic applications known in the art.

As used herein, the term “phase separation” does not imply that the reaction has reached thermodynamic equilibrium, but rather that the metals have separated from one another during the photoinduced reaction.

The term “nanoparticle” as used herein, refers to a two-metal composition that does not exhibit prismatic properties. The nanoparticle can be a core-shell structure or an alloy. Typically, a nanoparticle is less than about 1 μm in any one direction, but can be less than about 500 nm, less than about 200 nm, or less than about 100 nm. Alternatively, the nanoparticle can be up to about 5 μm.

The term “nanoprism,” as used herein, refers to a two-metal composition that exhibits prismatic properties. Such properties can be detected using known techniques. Prismatic properties include, but are not limited to, characteristic resonances, e.g., for silver nanoprisms, at about 330 nm (corresponding to an out-of-plane quadrupole resonance), about 450 nm (corresponding to an in-plane quadrupole resonance), and/or about 660 nm (corresponding to an in-plane dipole resonance).

### Two-Metal Nanoparticles

Ag—Au core-shell particles having different Ag:Au ratios (Ag:Au=20:1-5:1) have been synthesized using a two-step procedure: (1) preparation of the silver cores and (2) coating the Ag cores with gold (Cao et al., J. Am. Chem. Soc. 123:7961-7962 (2001)). In a typical experiment, small silver seeds first are prepared by rapidly injecting an ice cold, aqueous solution of a reducing agent, such as sodium borohydride (NaBH₄), into a vigorously stirring solution of a silver source, such as silver nitrate, and trisodium citrate. After about 5 to about 60 seconds, preferably about 15 seconds, an aqueous solution of a stabilizer, such as bis(sulfonatophenyl)phenyl phosphine dipotassium hydrate (BSPP) or poly(vinylpyrrolidone) (PVP), is added dropwise. The resulting mixture is allowed to stir for about 10 to about 60 minutes, preferably about 15 to about 30 minutes, and more preferably 20 minutes. The flask containing the Ag seeds then is immersed in an ice-bath and allowed to cool for about 10 to about 60 minutes, preferably about 15 to about 45 minutes, and more preferably about 30 minutes. After the seeds have cooled, additional reducing agent is added, and the resulting colloid allowed to stir for about 3 to about 15 minutes, preferably about 5 minutes.

At this point, an appropriate amount of a gold source, such as an aqueous gold (III) chloride (HAuCl₄) solution (5 mM), is added to the colloidal silver mixture. The gold source also can be other gold salts or hydrates. The amount of gold source added depends upon the desired molar ratio of Ag to Au. For example, for a Ag:Au molar ratio of about 20:1, about 100 μL of a 5 mM aqueous solution of a gold source is added; for a molar ratio of about 10:1, 200 μL is added, and for a molar ratio of about 5:1, 400 μL, is added. Other ratios of Ag:Au can be obtained based upon the disclosure herein. Other molar ratios of Ag:Au include about 1:1 to about 50:1, preferably about 2:1 to about 30:1, and more preferably about 5:1 to about 20:1. The greater the amount of Au added, the thicker the shell surrounding the Ag core, and the more shielding of the Ag from its surrounding environment. If the Au shell is too thick, the Ag is completely shielded, making it difficult to convert the Ag core to a nanoprism by irradiation. If the Au shell is too thin, the Ag is not sufficiently protected from its surrounding environment. The deposition of the Au on the Ag nanoparticles can be continuous or discontinuous, as long as sufficient Au is deposited on the Ag surface to protect the Ag.

Solutions of the prepared nanoparticles are dark yellow in color and exhibit a single surface plasmon band centered at 400 nm in their UV-vis spectra. The position of the surface plasmon band of the core-shell particles (400 nm) is not significantly shifted or broadened compared to the surface plasmon resonance of pure silver nanoparticles (395 nm), which confirms that the nanoparticles are core-shell particles, as opposed to alloy structures (Cao et al., J. Am. Chem. Soc. 123:7961-7962 (2001); Rivas et al., Langmuir 16:97229728 (2000); Link et al., J Phys Chem. B 103:3529-3533 (1999); Freeman et al., J. Phys, Chem 100:718-724 (1996); Shibata et al., J. Synchrotron Rad 8:545-547 (2001)).

Self nucleation of Au particles is greatly inhibited in the two step growth protocol disclosed herein. TEM and UV-vis spectroscopy show no evidence of pure Au nanoparticles, which exhibit a plasmon resonance in the 500-520 nm range. Small Au nanoparticles would be apparent in the TEM, and large gold nanoparticles (>4 nm) exhibit an intense plasmon resonance in their UV-vis spectra.

The resulting alloy or core-shell nanoparticles can be converted to two-metal nanoprisms by irradiation with a light source. The light source typically has a wavelength within the visible light spectrum (e.g., 350-750 nm), but can be any light source at any wavelength sufficient to convert the nanoparticle to a nanoprism. The length of time of the irradiation can be any time sufficient to allow the conversion to nanoprisms. Typically, irradiation is about 4 hours to about 500 hours, about 24 hours to about 500 hours, about 72 hours to about 450 hours, or about 120 hours to about 400 hours.

A colloid containing the disclosed core-shell particles was irradiated under ambient conditions with visible light (350-700 nm) for about two weeks using a 40 W fluorescent light tube (General Electric, Inc.). Particles having a higher gold content (e.g., Ag:Au<10:1) resulted in stable colloids, but the photoconversion reaction did not proceed. It is theorized that the lack of photocoversion is due to complete coverage of the silver cores with gold, which prevents a photochemical process at the silver surface.

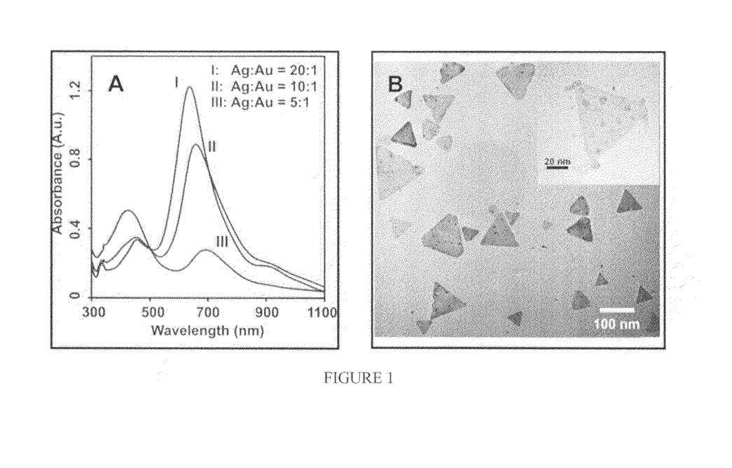

Nanoparticles having 20:1 and 10:1 Ag:Au ratios convert to nanoprisms as evidenced by the collapse of the surface plasmon band at about 400 nm for the nanoparticles, and the concomitant growth of new bands at 330 nm (corresponding to an out-of-plane quadrupole resonance), 450 nm (corresponding to an in-plane quadrupole resonance), and 660 nm (corresponding to an in-plane dipole resonance) (FIG. 1A). This process was accompanied by a gradual color change of the colloid from yellow to blue/green, indicating the formation of silver nanoprisms. The conversion occurred over the course of two weeks in light, and was significantly slower than the pure silver system, which took about 3 days.

TEM analysis confirmed the formation of nanoprisms. The two-metal nanoprisms derived from Ag:Au=10:1 colloids have a more polydisperse size distribution (e.g., average edge lengths 96 nm±28 nm, N=700) than a pure Ag system, but are considerably thinner (e.g., thickness=8.4 nm±1.7 nm, N=77) than those derived from pure Ag particles (e.g., thickness=16 nm). The observed difference in thickness may be due to the differences in growth of the nanostructures in solution. Although the surfaces of the resulting nanoprisms appear smooth and homogenous, the edges of the nanoprisms are quite jagged when viewed under TEM. The surfaces of the two-metal nanoprisms have small, spherical nanoparticles, which appear as bright spots in the TEM images, indicating a difference in composition (FIG. 1B).

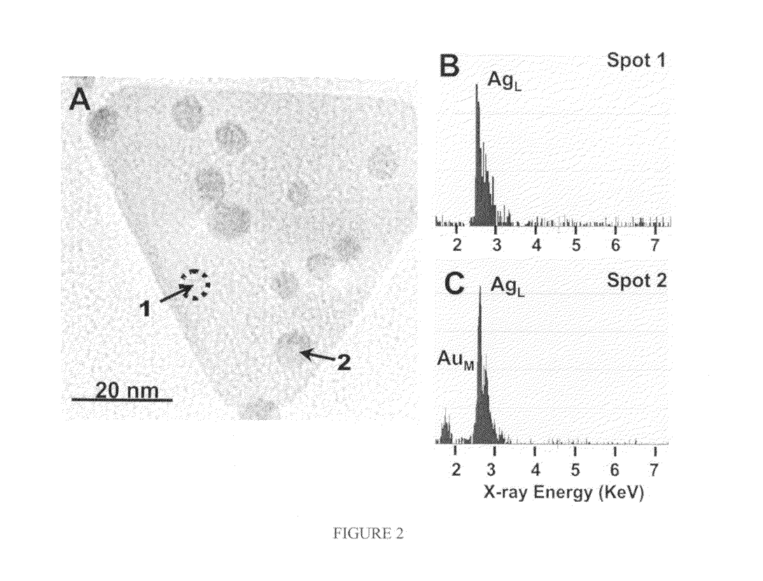

STEM used in conjunction with energy-dispersive X-ray emission spectroscopy (STEM-EDS) revealed that the nanoprisms are pure silver and that the spots are primarily gold (FIG. 2). This indicates that the two metals phase separate during the photo-conversion process. Additional TEM analysis indicates that gold nanoparticles deposit on the surface of the nanoprism, rather than embed in the silver matrix of the nanoprisms. This is observed most clearly on the edges of the nanoprisms, where small gold nanoparticles extend from the top (or bottom) surfaces of the silver prisms. Without being bound to theory, it is postulated that the gold nanoparticles deposit on the nanoprism surface during TEM sample preparation (drying), but remain dispersed in solution. Consistent with this hypothesis, some of the nanoprisms do not have spherical particles on their surface and many dispersed Au particles could be found on the TEM grid. The plasmon resonance associated with the about 5 nm Au particles cannot be observed because the Ag prisms are such strong absorbers in the visible region and the concentration of the gold particles in the colloid is relatively low.

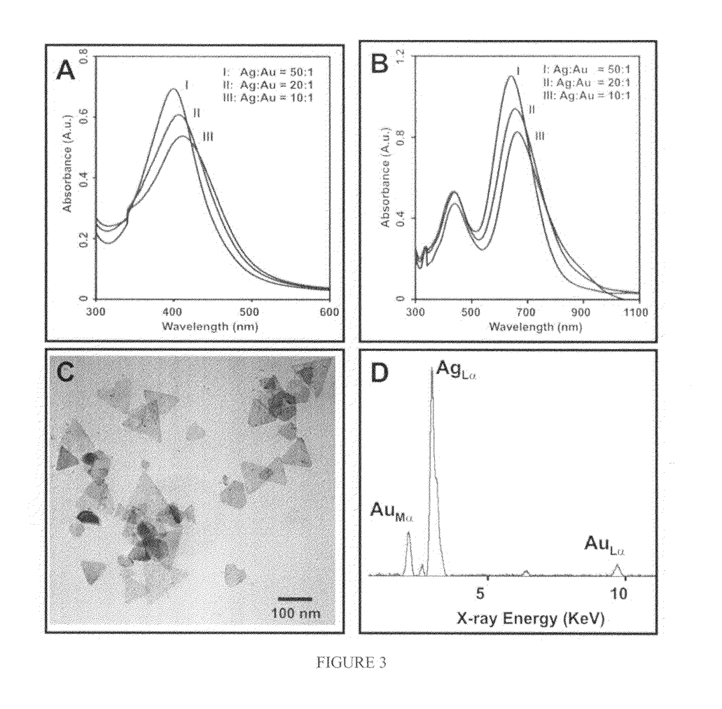

The shape, form, structure, or distribution of the precursor nanoparticles does not significantly affect the final structure of the nanoprisms. For example, gold-silver alloy nanoparticles irradiated under conditions comparable to the core-shell nanoparticles described above produced similar phase-separated structures. Alloy nanoparticles having Ag:Au ratios ranging from 50:1-10:1 were prepared via a co-reduction method (FIG. 3A) and studied in the context of the prism forming reaction. The photoconversion process from alloy nanoparticles to nanoprisms was slower for colloids having higher concentrations of gold. Samples containing Ag:Au=50:1 required about 4 days to fully form prisms, whereas as samples having Ag:Au of about 10:1 gold required two weeks. Over time, the surface plasmon bands of the alloy nanoparticles decrease in intensity with the concomitant growth of three new bands. Nanoparticles produced from a Ag:Au ratio of about 50:1, about 20:1, and about 10:1, possessed two bands centered at 330 nm (out-of-plane quadrupole resonance) and 430 nm (in-plane quadrupole resonance). The in-plane dipole resonance was much more sensitive to the precursor gold content and fell within about 640 to about 660 nm. The nanoprisms derived from the alloy nanoparticles having an Ag:Au ratio in the about 50:1 to about 10:1 range exhibit photoinduced phase separation similar to that observed for the core-shell system, yielding pure silver nanoprisms and nanoparticles composed primarily of gold. TEM microscopy revealed that the silver nanoprisms were approximately 92 nm (±30 nm, N=800) in edge length and 8.2 nm (±1.6 nm, N=361) thick (FIG. 3C). The edges of the silver nanoprisms derived from the alloy nanoparticles are roughened much like those derived from core-shell nanoparticles. EDX spectroscopy of the bulk colloid coupled with SEM of the bulk colloid revealed the existence of both gold and silver in the correct ratios before and after photoconversion (FIG. 3D).

Without being bound by any theory, it is postulated that the reason these two miscible metals (i.e., Ag and Au) phase separate during the disclosed method is due to the differences in reactivity between the metals towards light and oxygen. It has been demonstrated that plasmonic excitation of pure silver nanoparticles triggers conversion to larger nanoprisms. In contrast, similar experiments performed with gold have not yielded any change in nanoparticle size or shape and is due to the different reduction potential of the two metals. It is known that gold is much less susceptible to oxidation than silver (AuCl₄/Au₀=0.99 V, vs. SHE; Ag+/Ag₀=0.8 V vs. SHE) (CRC Handbook of Chemistry and Physics (Ed: D. R. Lide) CRC Press: Boca Raton, Fla., (1999)).

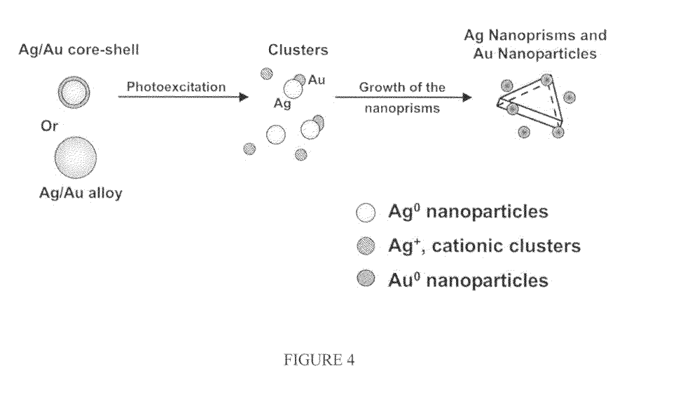

For pure silver nanoprisms, it has been observed that the photochemical reaction does not take place in the absence of oxygen, and increases as a function of increased oxygen concentration. The oxygen dependence is a result of a selective oxidation of the silver. In the case of the two-metal nanoparticles, plasmon-directed conversion to nanoprisms cannot be initiated when the Au shell is very thick (e.g., when the Ag:Au ratio is less than 10:1 for a core-shell structure) or the gold content is very high (e.g., when the Ag:Au ratio is less than 10:1 for an alloy). In view of these results, it is believed that oxidation selectively dissolves the silver component to create silver clusters in a partially oxidized state. This oxidation process continues as long as (a) the silver is accessible, (b) oxygen is present, and (c) the sample is irradiated. The silver species subsequently are reduced to form the nanoprisms, while the phase separated gold component agglomerates and grows pure Au nanoparticles (FIG. 4).

### Use of Two-Metal Nanoparticles

The disclosed two-metal nanoparticles can be used in a variety of applications. The core silver nanoprism can be used in plasmon resonance labeling. Use of silver nanoprisms is disclosed in U.S. Pat. Nos. 7,135,054 and 7,033,415, each of which is incorporated by reference in its entirety.

The gold on the surface of the two-metal nanoparticle can be used to modify the surface of the nanoparticle for use in a variety of applications, including, but not limited to, protein labeling, oligonucleotide detection, therapeutic applications, RNA interference, and the like. Such applications are disclosed in, for example, U.S. Ser. Nos. 09/344,667; 09/603,830; 09/760,500; 09/820,279; and 09/927,777; and in International Publication Nos. WO 98/04740; WO 01/00876; WO 01/51665; and WO 01/73123, the disclosures of which are incorporated by reference in their entirety.

These surface modified nanoprisms, then, can be used in detection of a target compound. In various embodiments, the target compound comprises at least two portions. The lengths of these portions and the distance(s), if any, between them are chosen so that when the surface-modified nanoprisms interact with the target compound a detectable change occurs. These lengths and distances can be determined empirically and will depend on the type of particle used and its size and the type of electrolyte which will be present in solutions used in the assay. Also, when a target compound is an oligonucleotide and is to be detected in the presence of other oligonucleotides or non-target compounds, the portions of the target to which the oligonucleotide(s) on the oligonucleotide-modified nanoprism is to bind must be chosen so that they contain a sufficiently unique sequence such that detection of the nucleic acid will be specific. These techniques are well known in the art and can be found, for example, in U.S. Pat. Nos. 6,986,989; 6,984,491; 6,974,669; 6,969,761; 6,962,786; 6,903,207; 6,902,895; 6,878,814; 6,861,221; 6,828,432; 6,827,979; 6,818,753; 6,812,334; 6,777,186; 6,773,884; 6,767,702; 6,759,199; 6,750,016; 6,740,491; 6,730,269; 6,726,847; 6,720,411; 6,720,147; 6,709,825; 6,682,895; 6,677,122; 6,673,548; 6,645,721; 6,635,311; 6,610,491; 6,582,921; 6,506,564; 6,495,324; 6,417,340; and 6,361,944, each of which is herein incorporated by reference in its entirety.

In embodiments where the target compound comprises an oligonucleotide, the detectable change that occurs upon hybridization of a target compound on an oligonucleotide-modified nanoprism to the target can be a color change, formation of aggregates of the oligonucleotide-modified nanoprism, and/or a precipitation of the aggregated oligonucleotide-modified nanoprism. The color changes can be observed with the naked eye or spectroscopically. The formation of aggregates of the oligonucleotide-modified nanoprism can be observed by electron microscopy, by nephelometry, or by the eye. The precipitation of the aggregated oligonucleotide-modified nanoprism can be observed with the naked eye or microscopically. Preferred are changes observable with the naked eye. Particularly preferred is a color change observable with the naked eye.

Examples of the uses of the method for identifying a target compound include but are not limited to, the diagnosis and/or monitoring of viral diseases (e.g., human immunodeficiency virus, hepatitis viruses, herpes viruses, cytomegalovirus, and Epstein-Barr virus), bacterial diseases (e.g., tuberculosis, Lyme disease, H. pylori, Escherichia coli infections, Legionella infections, Mycoplasma infections, Salmonella infections), sexually transmitted diseases (e.g., gonorrhea), inherited disorders (e.g., cystic fibrosis, Duchene muscular dystrophy, phenylketonuria, sickle cell anemia), and cancers (e.g., genes associated with the development of cancer); in forensics; in DNA sequencing; for paternity testing; for cell line authentication; for monitoring gene therapy; and for many other purposes.

In various embodiments, the detection of a target compound is used in conjunction with drug discovery or DNA or oligonucleotide interacting compounds (e.g., intercalators and binders). A target compound can be assessed for its ability to specifically bind to a known oligonucleotide, which is bound to the surface of a nanoprism disclosed herein.

As used herein, the term “oligonucleotide” refers to a single-stranded oligonucleotide of 200 or less nucleobases. Methods of making oligonucleotides of a predetermined sequence are well-known. See, e.g., Sambrook et al., Molecular Cloning: A Laboratory Manual (2nd ed. 1989) and F. Eckstein (ed.) Oligonucleotides and Analogues, 1st Ed. (Oxford University Press, New York, 1991). Solid-phase synthesis methods are preferred for both oligoribonucleotides and oligodeoxyribonucleotides (the well-known methods of synthesizing DNA are also useful for synthesizing RNA). Oligoribonucleotides and oligodeoxyribonucleotides can also be prepared enzymatically.

In various aspects, the oligonucleotide which modified the surface of a nanoprism disclosed herein is about 5 to about 100 nucleotides in length, about 5 to about 90 nucleotides in length. about 5 to about 80 nucleotides in length, about 5 to about 70 nucleotides in length, about 5 to about 60 nucleotides in length, about 5 to about 50 nucleotides in length, about 5 to about 45 nucleotides in length, about 5 to about 40 nucleotides in length, about 5 to about 35 nucleotides in length, about 5 to about 30 nucleotides in length, about 5 to about 25 nucleotides in length, about 5 to about 20 nucleotides in length, about 5 to about 15 nucleotides in length, or about 5 to about 10 nucleotides in length. Methods are provided wherein the oligonucleotide is a DNA oligonucleotide, an RNA oligonucleotide, or a modified form of either a DNA oligonucleotide or an RNA oligonucleotide.

In various aspects, the methods include use of an oligonucleotide which is 100% complementary to the target oligonucleotide, i.e., a perfect match, while in other aspects, the oligonucleotide is at least (meaning greater than or equal to) about 95% complementary to the target compound over the length of the oligonucleotide, at least about 90%, at least about 85%, at least about 80%, at least about 75%, at least about 70%, at least about 65%, at least about 60%, at least about 55%, at least about 50%, at least about 45%, at least about 40%, at least about 35%, at least about 30%, at least about 25%, at least about 20% complementary to the target compound over the length of the oligonucleotide to the extent that the oligonucleotide is able to achieve the desired degree of [inhibition of a target gene product.

Examples of one class of target compounds that can be detected by the method of the present invention includes but is not limited to genes (e.g., a gene associated with a particular disease), viral RNA and DNA, bacterial DNA, fungal DNA, cDNA, mRNA, RNA and DNA fragments, oligonucleotides, synthetic oligonucleotides, modified oligonucleotides, single-stranded and double-stranded nucleic acids, natural and synthetic nucleic acids, and the like. The target compound may be isolated by known methods, or may be detected directly in cells, tissue samples, biological fluids (e.g., saliva, urine, blood, serum), solutions containing PCR components, solutions containing large excesses of oligonucleotides or high molecular weight DNA, and other samples, as also known in the art. 15 See, e.g., Sambrook et al., Molecular Cloning: A Laboratory Manual (2nd ed. 1989) and B. D. Hames and S. J. Higgins, Eds., Gene Probes 1 (IRL Press, New York, 1995).

In various aspects of the method, a plurality of oligonucleotides may be attached to the nanoprism. As a result, each oligonucleotide-modified nanoprism can have the ability to bind to a plurality of target compounds. In various aspects of the method the plurality of oligonucleotides may be identical. Methods are also contemplated wherein the plurality of oligonucleotides includes about 10 to about 100,000 oligonucleotides, about 10 to about 90,000 oligonucleotides, about 10 to about 80,000 oligonucleotides, about 10 to about 70,000 oligonucleotides, about 10 to about 60,000 oligonucleotides, 10 to about 50,000 oligonucleotides, 10 to about 40,000 oligonucleotides, about 10 to about 30,000 oligonucleotides, about 10 to about 20,000 oligonucleotides, about 10 to about 10,000 oligonucleotides, and all numbers of oligonucleotides intermediate to those specifically disclosed to the extent that the oligonucleotide-modified nanoprism is able to achieve the desired result.

In various aspects of the methods, at least one oligonucleotide is bound to the nanoprism through a 5′ linkage and/or the oligonucleotide is bound to the nanoprism through a 3′ linkage. In various aspects, at least one oligonucleotide is bound through a spacer to the nanoprism. In these aspects, the spacer is an organic moiety, a polymer, a water-soluble polymer, a nucleic acid, a polypeptide, and/or an oligosaccharide. Methods of functionalizing the oligonucleotides to attach to a surface of a nanoparticle are well known in the art. See Whitesides, Proceedings of the Robert A. Welch Foundation 39th Conference On Chemical Research Nanophase Chemistry, Houston, Tex., pages 109-121 (1995). See also, Mucic et al. Chem. Comm. 555-557 (1996) (describes a method of attaching 3′ thiol DNA to flat gold surfaces; this method can be used to attach oligonucleotides to nanoparticles). The alkanethiol method can also be used to attach oligonucleotides to other metal, semiconductor and magnetic colloids and to the other nanoparticles listed above. Other functional groups for attaching oligonucleotides to solid surfaces include phosphorothioate groups (see, e.g., U.S. Pat. No. 5,472,881 for the binding of oligonucleotide-phosphorothioates to gold surfaces), substituted alkylsiloxanes (see, e.g. Burwell, Chemical Technology, 4:370-377 (1974) and Matteucci and Caruthers, J. Am. Chem. Soc., 103:3185-3191 (1981) for binding of oligonucleotides to silica and glass surfaces, and Grabaretal., Anal. Chem., 67:735-743 for binding of aminoalkylsiloxanes and for similar binding of mercaptoaklylsiloxanes). Oligonucleotides terminated with a 5′ thionucleoside or a 3′ thionucleoside may also be used for attaching oligonucleotides to solid surfaces. The following references describe other methods which may be employed to attached oligonucleotides to nanoparticles: Nuzzo et al., J. Am. Chem. Soc., 109:2358 (1987) (disulfides on gold); Allara and Nuzzo, Langmuir, 1:45 (1985) (carboxylic acids on aluminum); Allara and Tompkins, J. Colloid Interface Sci., 49:410-421 (1974) (carboxylic acids on copper); Iler, The Chemistry Of Silica, Chapter 6, (Wiley 1979) (carboxylic acids on silica); Timmons and Zisman, J. Phys. Chem., 69:984-990 (1965) (carboxylic acids on platinum); Soriaga and Hubbard, J. Am. Chem. Soc., 104:3937 (1982) (aromatic ring compounds on platinum); Hubbard, Acc. Chem. Res., 13:177 (1980) (sulfolanes, sulfoxides and other functionalized solvents on platinum); Hickman et al., J. Am. Chem. Soc., 111:7271 (1989) (isonitriles on platinum); Maoz and Sagiv, Langmuir, 3:1045 (1987) (silanes on silica); Maoz and Sagiv, Langmuir, 3:1034 (1987) (silanes on silica); Wasserman et al., Langmuir, 5:1074 (1989) (silanes on silica); Eltekova and Eltekov, Langmuir, 3:951 (1987) (aromatic carboxylic acids, aldehydes, alcohols and methoxy groups on titanium dioxide and silica); Lec et al., J. Phys. Chem., 92:2597 (1988) (rigid phosphates on metals).

The contacting of the oligonucleotide-modified nanoprism with the target compound takes place under conditions effective for hybridization of the oligonucleotide on the oligonucleotide-modified nanoprism with the target sequence of the target oligonucleotide. “Hybridization” means an interaction between two strands of nucleic acids by hydrogen bonds in accordance with the rules of Watson-Crick DNA complementarity, Hoogstein binding, or other sequence-specific binding known in the art. Hybridization can be performed under different stringency conditions known in the art. These hybridization conditions are well known in the art and can readily be optimized for the particular system employed. See, e.g., Sambrook et al., Molecular Cloning: A Laboratory Manual (2nd ed. 1989). Preferably stringent hybridization conditions are employed. Under appropriate stringency conditions, hybridization between the two complementary strands could reach about 60% or above, about 70% or above, about 80% or above, about 90% or above, about 95% or above, about 96% or above, about 97% or above, about 98% or above, or about 99% or above in the reactions.

Faster hybridization can be obtained by freezing and thawing a solution containing the oligonucleotide to be detected and the oligonucleotide-modified nanoprism. The solution may be frozen in any convenient manner, such as placing it in a dry ice-alcohol bath for a sufficient time for the solution to freeze (generally about 1 minute for 100 μl it of solution). The solution must be thawed at a temperature below the thermal denaturation temperature, which can conveniently be room temperature for most combinations of oligonucleotide-modified nanoprism and target oligonucleotides. The hybridization is complete, and the detectable change may be observed, after thawing the solution. The rate of hybridization can also be increased by warming the solution containing the target compound and the oligonucleotide-modified nanoprism to a temperature below the dissociation temperature (Tₘ) for the complex formed between the oligonucleotide on oligonucleotide-modified nanoprism and the target compound. Alternatively, rapid hybridization can be achieved by heating above the dissociation temperature (Tₘ) and allowing the solution to cool. The rate of hybridization can also be increased by increasing the salt concentration (e.g., from 0.1 M to 0.3 M sodium chloride).

In other embodiments of the invention, methods are provided which are variations of the methods disclosed in WO 2005/003394, the disclosure of which of is incorporated by reference in its entirety. In variation of the methods discloses therein, one or more of the particles used in the methods are replaced with a nanoprism of the invention. Alternatively, substrates used in the methods disclosed in WO 2005/003394 are replaced with nanoprisms of the invention.

### Examples

Silver nitrate (AgNO₃), trisodium citrate, poly(vinylpyrrolidone) (PVP), and sodium borohydride (NaBH₄) were purchased from Aldrich (Milwaukee, Wis. USA). Bis(p-sulfanatophenyl)phenyl phosphine dipotassium dihydrate salt (BSPP) was purchased from Strem Chemicals (Newburyport, Mass. USA). All chemicals were used as received. All water was purified using a Nanopure water system (Ω=18.2 MΩ, Barnstead Ins.).

Ag—Au core-shell nanoparticles. An aqueous solution of AgNO₃ (0.1 mM 100 mL) and trisodium citrate (0.3 mM) was stirred vigorously in a round-bottom flask at room temperature in the presence of air. To this mixture, 0.5 mL of freshly prepared, ice-cold (about 0° C.) NaBH₄ (100 mM) was rapidly injected. The reaction mixture turned pale yellow and was allowed to stir for 10-15 seconds before addition of 1 mL of bis(p-sulfonatophenyl)phenyl phosphine dipotassium salt (BSSP, 5 mM). BSPP was added in a dropwise fashion over the course of 30 seconds. Core-shell nanoparticles protected with polyvinyl-2-pyrrolidone) (1 mL of 0.7 mM solution) exhibited similar optical properties and chemical reactivity as those coated with BSPP. Stirring of the silver seed solution was stopped when the surface plasmon band (about 395 nm) had reached a maximum intensity and was stable (both in intensity and position).

The flask containing the Ag seeds subsequently was immersed in an ice-bath and allowed to cool for approximately 30 minutes. Once the seeds cooled, additional NaBH₄ (0.2 mL, 100 mM) was added, and the colloid was allowed to stir for an additional 5 minutes. At this point, aqueous HAuCl₄ solution (5 mM) was added to the stirring colloid to yield gold-coated silver nanoparticles. For Ag:Au=20:1, 10:1, and 5:1, the volumes of HAuCl₄ used were 100 μL, 200 μL, and 400 μL HAuCl₄, respectively. The gold solution first was diluted to 1 mL with Nanopure (Ω=18.2 MΩ) water, then added slowly (5 minutes) and in a dropwise fashion to the colloid. The final gold-coated silver nanoparticle colloids were dark yellow in color and exhibited a single band centered at 400 nm in its UV-vis spectrum.

Au—Ag alloy nanoparticles. In a typical experiment, an aqueous solution of AgNO₃ (0.1 mM, 100 mL), HAuCl₄ (0.01-0.005 mM), and trisodium citrate (0.3 mM) was rapidly stirred at room temperature and in the presence of air. The silver subsequently was reduced by injection of NaBH₄ (100 mM, 0.5 mL) and allowed to stir for 10-15 seconds. The colloid immediately became dark yellow and clear. BSPP (1 mL) was added dropwise to the stirring colloid over the course of 20-30 seconds. The colloid was allowed to continue stirring for 20-30 minutes and subsequently placed in a glass vial. The color of the Au—Ag alloy nanoparticles varied depending on the gold content and ranged from dark yellow (low Au) to orange/yellow (high Au). The dipole resonance of the initial nanoparticles red-shifts with increasing content of gold (400 nm for Ag:Au of 50:1 to 415 for Ag:Au of 10:1). The presence of only one band at 400-415 nm (depending on the Au content) in the spectrum confirmed that alloy nanoparticles, rather than separate pure gold and silver particles, were formed in the co-reduction reaction. The surface plasmon absorption band decreased in intensity and red-shifted with increasing gold ratios in the alloy nanoparticles (FIG. 3A). Alloy nanoparticle colloids with Ag:Au ratios less than a Ag:Au ratio of about 10:1 (e.g., Ag:Au of 5:1 or 1:1) resulted in precipitation after several days in light.

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

What is claimed:

1. A method of preparing a nanoprism comprising the steps of
a) admixing a silver nanoparticle and a gold source under conditions that deposit gold on a surface of the silver nanoparticle to form a two-metal nanoparticle; and
b) irradiating the two-metal nanoparticle with a light source to form a nanoprism.

2. A method of preparing a nanoprism comprising the step of irradiating a nanoparticle of a silver-gold alloy with a light source to form the nanoprism.

3. The method of claim 1 or 2, wherein the irradiating is for about 4 hours to about 500 hours.

4. The method of claim 1 or 2, wherein the irradiating comprises a light source having a wavelength of about 400 nm to about 700 nm.

5. The method of claim 1 or 2, wherein the molar ratio of silver to gold is about 1:1 to about 50:1.

6. The method of claim 1 or 2, wherein the molar ratio of silver to gold is about 2:1 to about 30:1.

7. The method of claim 1 or 2, wherein the molar ratio of silver to gold is about 10:1 to about 20:1.

8. The method of claim 1, wherein the two-metal nanoparticle exhibits a surface plasmon resonance of about 375 nm to about 425 nm.

9. The method of claim 1 or 2, wherein the nanoprism exhibits an out-of-plane quadrupole resonance of about 325 nm to about 335 nm, an in-plane quadrupole resonance of about 445 nm to about 455 nm, an in-plane dipole resonance of about 640 nm to about 660 nm, or combinations thereof.

10. The method of claim 1 or 2 further comprising the step of:
modifying the gold on a surface of the nanoprism with a protein, oligonucleotide, or combination thereof.

11. A nanoprism produced by the method of claim 1 or 2, wherein the prismatic properties of the silver are protected from a surrounding environment by the gold.

12. The method of claim 1 or 2 wherein the nanoprism is a silver nanoprism having gold nanoparticles on surfaces of the nanoprism.

13. The nanoprism of claim 11 having an out-of-plane quadrupole resonance of about 325 nm to about 335 nm, an in-plane quadrupole resonance of about 445 nm to about 455 nm, an in-plane dipole resonance of about 640 nm to about 660 nm, or combinations thereof.

14. The nanoprism of claim 11 having an edge length of about 70 nm to about 120 nm and a thickness of about 6.5 to about 10.5 nm.

15. The nanoprism of claim 11 having an edge length of about 90 nm to about 100 nm.

16. The nanoprism of claim 11 having a thickness of about 8.0 to about 9.0 nm.

17. The nanoprism of claim 11 having a surface modified with an oligonucleotide, a protein, or a combination thereof.

18. A silver nanoprism having gold nanoparticles on the nanoprism surface.
